(19) United States
(12) Patent Application Publication
(10) Pub. No.: US 2014/0367877 A1
(43) Pub. Date: Dec. 18, 2014

(54) METHOD FOR MANUFACTURING INSULATING HOUSING

(71) Applicants: Inventec (Pudong) Technology Corporation, Shanghai (CN); Inventec Corporation, Taipei (TW)

(72) Inventors: Yi-Lun CHENG, Taipei (TW); Chun-Lung LIN, Taipei (TW)

(73) Assignees: Inventec (Pudong) Technology Corporation, Shanghai (CN); Inventec Corporation, Taipei (TW)

(21) Appl. No.: 14/249,140

(22) Filed: Apr. 9, 2014

(30) Foreign Application Priority Data
Jun. 17, 2013 (CN) 201310239722.8

(51) Int. Cl. B29C 45/00

(52) U.S. Cl. CPC B29C 45/0001
USPC 264/45.3

(57) ABSTRACT

One embodiment of the disclosure provides a method for manufacturing a thermally insulating housing and the method includes the following step. First, a plastic housing is formed by a Gas-Assisted Injection Molding (GAIM) process, and the plastic housing includes at least one air-tight chamber. Therefore, the thermally insulating housing enhances the thermally insulating effect.

### CROSS-REFERENCE TO RELATED APPLICATIONS

This non-provisional application claims priority under 35 U.S.C. §119(a) on Patent Application No(s). 201310239722.8 filed in China on Jun. 17, 2013, the entire contents of which are hereby incorporated by reference.

### BACKGROUND OF THE INVENTION

1. Technical Field of the Invention

The disclosure relates to a method for manufacturing a thermally insulating housing, more particularly to a method for manufacturing a thermally insulating housing which applies an injection molding process.

2. Description of the Related Art

With the developments of electronic technology, the performances of the electronic devices are enhanced accordingly. In order to meet the demand of consumers for the performances of the electronic devices, manufacturers have dedicated to develop the electronic devices to improve their performances with a large amount of researching and developing costs.

Because of the improvements of the electronic devices, the amount of heat generated by the electronic devices is greatly increased, such that the temperature of the whole electronic device is increased. When the temperature of the surface of the electronic device is too high and a user directly touches the surface, the user may feel uncomfortable because of the high temperature. In order to prevent the temperature of the surface from being too high, an aluminum coil or a graphite sheet is disposed on a plastic housing of the electronic device. The heat may be quickly dissipated through the aluminum coil or the graphite sheet. However, the structure of the aluminum coil or the graphite sheet being disposed on the plastic housing needs additional manufacturing processes, which increases the manufacturing costs. Moreover, in recent years, in order to meet the ergonomic design, the cross-sectional shape of the housing is polygonal or has several curved surfaces, but the aluminum coil or the graphite sheet may not be evenly attached on the surface, thereby reducing the heat dissipation efficiency. In view of this, how to manufacture a housing of the electronic device without the aluminum coil or the graphite sheet as well as having good heat dissipation efficiency is the problem that the manufacturers try to solve.

### SUMMARY OF THE INVENTION

One embodiment of the disclosure provides a method for manufacturing a thermally insulating housing which includes the following step. A plastic housing is formed by a Gas-Assisted Injection Molding (GAIM) process, and the plastic housing includes at least one air-tight chamber.

### BRIEF DESCRIPTION OF THE DRAWINGS

The disclosure will become more fully understood from the detailed description given herein below for illustration only, thus does not limit the disclosure, wherein:

FIG. 1 is a flow chart of a method for manufacturing a thermally insulating housing according to a first embodiment of the disclosure;

FIG. 2 is a schematic cross-sectional view of a thermally insulating housing according to a first embodiment of the disclosure;

FIG. 3 is a schematic cross-sectional view of a thermally insulating housing according to a second embodiment of the disclosure;

FIG. 4 is a schematic cross-sectional view of a thermally insulating housing according to a third embodiment of the disclosure;

FIG. 5 is a flow chart of a method for manufacturing a thermally insulating housing according to a fourth embodiment of the disclosure;

FIG. 6 is a schematic cross-sectional view of a thermally insulating housing according to a fourth embodiment of the disclosure;

FIG. 7 is a schematic cross-sectional view of a phase-change-material microcapsule according to an embodiment of the disclosure;

FIG. 8 is a schematic cross-sectional view of a thermally insulating housing according to a fifth embodiment of the disclosure;

FIG. 9 is a schematic cross-sectional view of a thermally insulating housing according to a sixth embodiment of the disclosure; and

FIG. 10 is a schematic cross-sectional view of a thermally insulating housing according to a seventh embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

It will be understood that relative terms, such as “lower” or “bottom”, “upper” or “top,” and “left” or “right” may be used herein to describe one element's relationship to another element as illustrated in the Figures. The relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” other elements would then be oriented “above” the other elements. The exemplary terms “below” can, therefore, encompass both an orientation of above and below.

One embodiment of the disclosure provides a method for manufacturing a thermally insulating housing, in order to increase the heat dissipation of the thermally insulating housing.

In this disclosure, the thermally insulating housing is applied in an electronic device, e.g., laptop computer, mobile phone, tablet computer, electronic dictionary or handheld game console, but is not limited to the disclosure. Moreover, the thermally insulating housing includes an accommodating space which contains at least one electronic component. When the electronic device is used, the at least one electronic component operates and generates heat accordingly. Consequently, the temperature of the electronic component rises, and the heat is transferred to the thermally insulating housing.

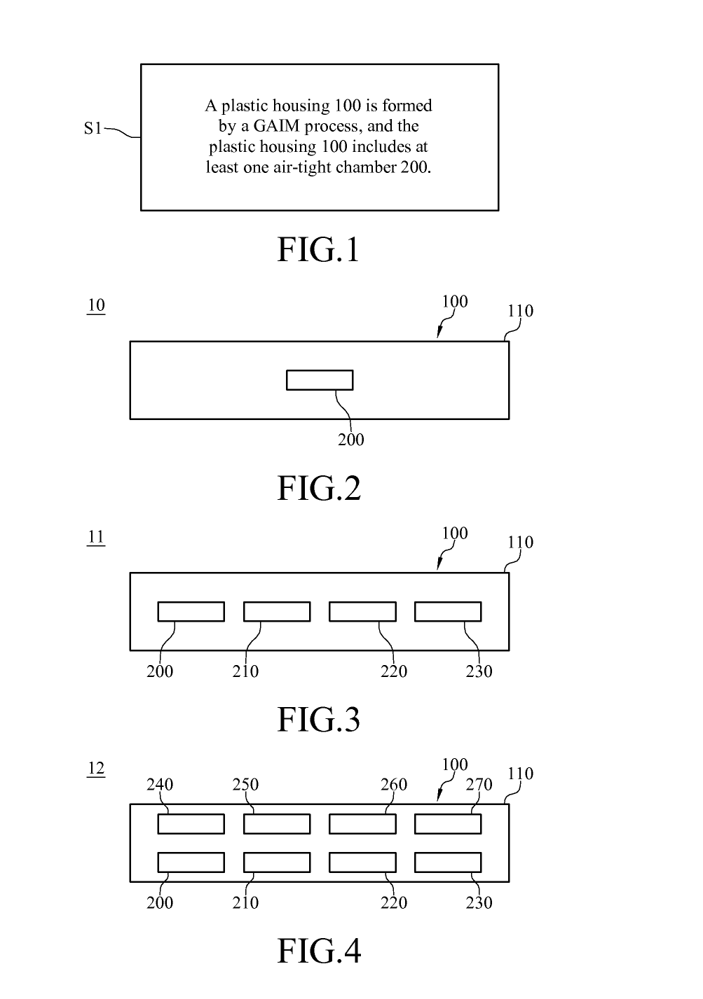

Please refer to FIGS. 1 and 2 together. FIG. 1 is a flow chart of a method for manufacturing a thermally insulating housing according to a first embodiment of the disclosure. FIG. 2 is a schematic cross-sectional view of a thermally insulating housing according to a first embodiment of the disclosure.

An embodiment of the disclosure provides a method for manufacturing the thermally insulating housing 10. The method comprises:

Step 1 (S1): A plastic housing 100 is formed by a Gas-Assisted Injection Molding (GAIM) process, and the plastic housing 100 includes at least one air-tight chamber 200. The air-tight chamber 200 is a closed room where outside air cannot flow through, thereby achieving the thermally insulating effect. The plastic housing 100 includes an upper surface 110. Moreover, the volume of each of the air-tight chambers 200 is between 0.125 mm³ to 8 mm³. In this embodiment, the number of air-tight chambers 200 is one, but the number and location of the at least one air-tight chambers 200 are not limited to the disclosure. The cross-sectional shape of the air-tight chamber 200 is square, rectangular, round, oval or polygonal, but is not limited to the disclosure. The number, cross-sectional shape and location of the at least one air-tight chamber 200 are adjusted according to actual requirements. Furthermore, in this embodiment, the material of the plastic housing 100 is a mixture of polycarbonate (PC) and acrylonitrile butadiene styrene resin (ABS Resin), but is not limited to the disclosure.

The GAIM process is that certain gas (e.g. nitrogen) pushes against a plastic material to perform the injection molding, and the pressure of a chamber within the plastic material is maintained. After the plastic housing 100 is formed and the injection molding is finished, the plastic housing 100 is cooled down, and some of the gas inside the air-tight chamber 200 may be retrieved or discharged. Therefore, air may be maintained within the air-tight chamber 200. In comparison with the plastic housing 100, the thermal conductivity of the air is lower. Therefore, the air-tight chamber 200 becomes a better thermal insulating room, thereby enhancing the whole heat-dissipation control of the plastic housing. Consequently, an aluminum coil or a graphite sheet does not need to be attached to the surface of the plastic housing 100 so the additional manufacturing cost, for attaching the aluminum coil or the graphite sheet to the plastic housing 100 in order to enhance the heat dissipation, is saved. In other embodiments, the number of the air-tight chambers 200 is a positive integral larger than one. Please refer to FIG. 3, which is a schematic cross-sectional view of a thermally insulating housing according to a second embodiment of the disclosure. The configuration of this embodiment is similar to that of the first embodiment, therefore the same numeral represents similar structures and the repeated description is not described again herein. In this embodiment, a plastic housing 100 of a thermally insulating housing 11 is formed by the GAIM process, and the plastic housing 100 includes four air-tight chambers 200, 210, 220 and 230 that are evenly distributed within the plastic housing 100. Therefore, the evenly distributed air-tight chambers 200, 210, 220 and 230 may enhance the heat dissipation of the plastic housing 100.

Please refer to FIG. 4, which is a schematic cross-sectional view of a thermally insulating housing according to a third embodiment of the disclosure. The configuration of this embodiment is similar to that of the first embodiment, therefore the same numeral represents similar structures and the repeated description is not described herein. In this embodiment, a plastic housing 100 of a thermally insulating housing 12 is formed by the GAIM process, and the plastic housing 100 includes eight air-tight chambers 200, 210, 220, 230, 240, 250, 260 and 270. The air-tight chambers 200, 210, 220 and 230 are arranged in a row. The air-tight chambers 240, 250, 260 and 270 are arranged in another row as well as being closer to an upper surface 110. Furthermore, as shown in FIG. 4, the air-tight chamber 240 is disposed above the air-tight chamber 200, the air-tight chamber 250 is disposed above the air-tight chamber 210, the air-tight chamber 260 is disposed above the air-tight chamber 220, and the air-tight chamber 270 is disposed above the air-tight chamber 230. The array of the air-tight chambers 200, 210, 220, 230, 240, 250, 260 and 270 may enhance the heat dissipation of the plastic housing 100.

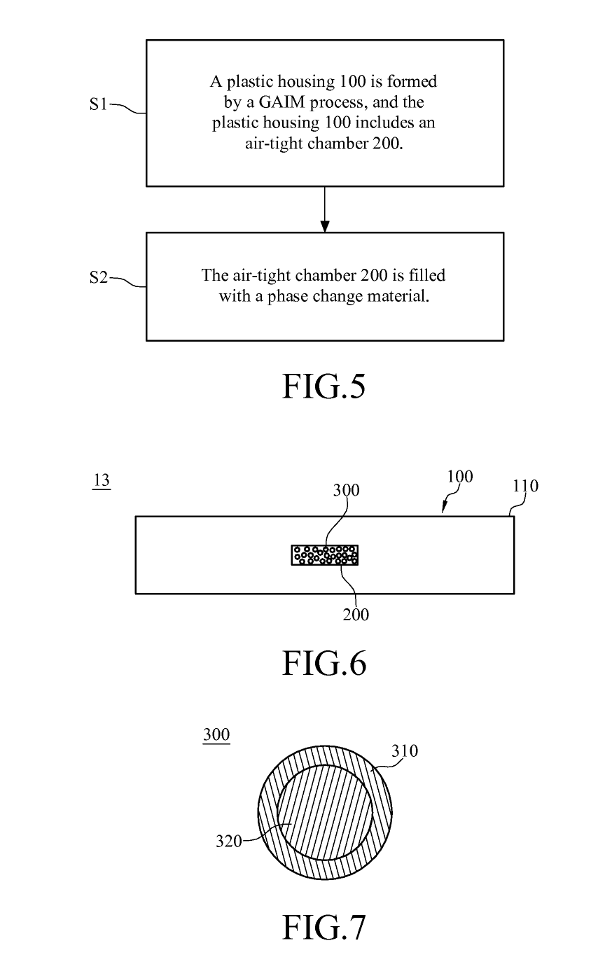

Please refer to FIGS. 5 and 6. FIG. 5 is a flow chart of a method for manufacturing a thermally insulating housing according to a fourth embodiment of the disclosure, and FIG. 6 is a schematic cross-sectional view of a thermally insulating housing according to a fourth embodiment of the disclosure. The configuration of this embodiment is similar to that of the first embodiment, therefore the same numeral represents similar structures and the repeated description is not described again herein.

In the method for forming a thermally insulating housing 13 according to the fourth embodiment of the disclosure, first, a plastic housing 100 is formed by the GAIM process, and the plastic housing 100 includes an air-tight chamber 200 (S1). Then, the air-tight chamber 200 is filled with a phase change material (Step 2, S2).

According to the disclosure, the phase change material has great latent heat, that is, the phase change material has an advantage of absorbing great heat energy during the change of phase. As a result, the heat dissipation of the plastic housing 100 is enhanced. Moreover, in the thermally insulating housing 13, an aluminum coil or a graphite sheet does not need to be attached to the upper surface 110 or other surfaces of the plastic housing 100. Therefore, the thermally insulating housing 13 solves the problem that additional manufacturing costs are required by attaching the aluminum coil or the graphite sheet to the plastic housing 100 for enhancing the heat dissipation.

Please refer to FIGS. 6 and 7, FIG. 6 is a schematic cross-sectional view of a thermally insulating housing according to a fourth embodiment of the disclosure, and FIG. 7 is a schematic cross-sectional view of a phase-change-material microcapsule according to an embodiment of the disclosure. In this embodiment, the phase change material is enclosed by a plurality of phase-change-material microcapsules 300. Each of the phase-change-material microcapsules 300 comprises a capsule shell 310 and a capsule core 320. The capsule core 320 is disposed within the capsule shell 310. The material of the capsule shell 310 is polymer, and the capsule core 320 comprises the above-mentioned phase change material. In this embodiment, the polymer, which forms the capsule shell 310, is a mixture of PC and glass fiber (GF), and the phase change material of the capsule core 320 is paraffin wax or alkanes. Moreover, in one embodiment, the phase change material of the capsule core 320 is icosane (namely, eicosane). Therefore, when the electronic device is operated, the temperature of the thermally insulating housing 13 rises, and the temperature of the surface of the plastic housing 100 is controlled to maintain at 37° C. In another embodiment, the phase change material of the capsule core 320 is triacontane. When the electronic device is operated, the temperature of the thermally insulating housing 13 rises, and the temperature of the surface of the plastic housing 100 is controlled to maintain at 66° C. Therefore, the heat-dissipation control of the thermally insulating housing 13 is improved.

However, the above-mentioned phase change material is phase-change-material microcapsule 300, but is not limited to the disclosure. In other embodiments, the phase change material is a non-microcapsule phase change substance. The non-microcapsule phase change substance is a high-latent-heat material, e.g., paraffin wax or alkanes. The alkanes are icosane or triacontane, but are adjusted according to actual requirements.

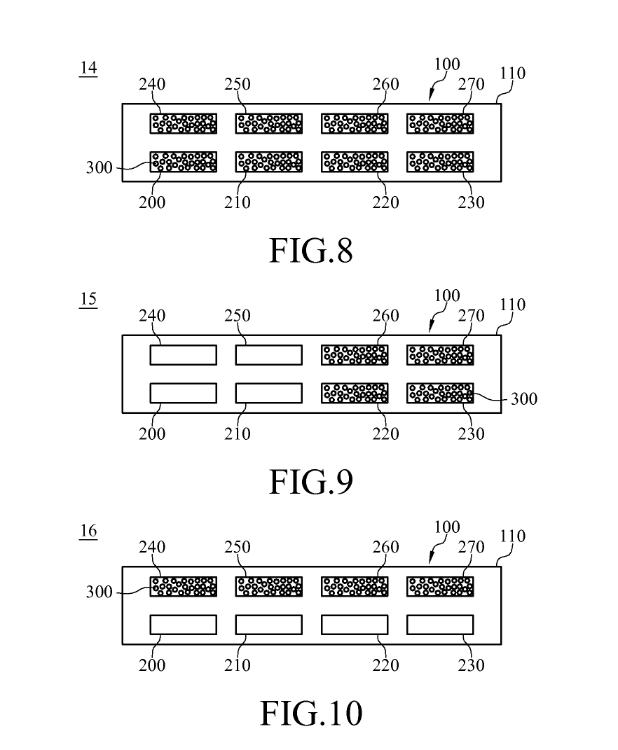

However, the number of the above-mentioned air-tight chambers 200 is not limited to the disclosure. Please refer to FIG. 8, which is a schematic cross-sectional view of a thermally insulating housing according to a fifth embodiment of the disclosure. The configuration of this embodiment is similar to that of the fourth embodiment, therefore the same numeral represents similar structures and the repeated description is not described again herein. In this embodiment, a plastic housing 100 of a thermally insulating housing 14 includes eight air-tight chambers 200, 210, 220, 230, 240, 250, 260 and 270, and each of the eight air-tight chambers 200, 210, 220, 230, 240, 250, 260 and 270 contains a plurality of phase-change-material microcapsules 300. Therefore, the air-tight chambers 200, 210, 220, 230, 240, 250, 260 and 270 which contain the phase-change-material microcapsules 300 may enhance the heat dissipation of the thermally insulating housing 13.

According to the disclosure, the air-tight chamber 200 may contain the phase-change-material microcapsule 300 or the air-tight chamber 200 may only contain gas. Please refer to FIG. 9, which is a schematic cross-sectional view of a thermally insulating housing according to a sixth embodiment of the disclosure. The configuration of this embodiment is similar to that of the fourth embodiment, therefore the same numeral represents similar structures and the repeated description is not described again herein. In a plastic housing 100 according to this embodiment, in order to enhance the heat dissipation of the right side of the plastic housing 100 of a thermally insulating housing 15, as shown in FIG. 9, each of the air-tight chambers 220, 230, 260 and 270 contains a plurality of the phase-change-material microcapsules 300, and each of the air-tight chambers 200, 210, 240 and 250 only contains air. Therefore, the right side of the thermally insulating housing 15 has better heat-dissipation capability, thereby achieving better heat-dissipation control of the thermally insulating housing 15.

Please refer to FIG. 10, which is a schematic cross-sectional view of a thermally insulating housing according to a seventh embodiment of the disclosure. The configuration of this embodiment is similar to that of the fourth embodiment, therefore the same numeral represents similar structures and the repeated description is not described again herein. In a thermally insulating housing 16 according to this embodiment, in order to enhance the thermal insulating and heat-dissipation capability of the upper surface 110 of the plastic housing 100, each of the air-tight chambers 240, 250, 260 and 270 contains a plurality of phase-change-material microcapsules 300, and each of the air-tight chambers 200, 210, 220 and 230 only contains air. Therefore, the thermal insulating capability of the upper surface 110 of the plastic housing 100 is enhanced, thereby optimizing the heat-dissipation control of the thermally insulating housing 16.

According to the method for manufacturing the thermally insulating housing, the air-tight chamber is located within the plastic housing, the air-tight chamber insulates the heat conduction, thereby enhancing the heat dissipation. Moreover, an aluminum coil or a graphite sheet does not need to be attached to the thermally insulating housing in this disclosure. Therefore, the additional manufacturing cost, caused by the attachment of the aluminum coil or graphite sheet, is saved. Moreover, when the air-tight chamber contains the phase change material, the thermal insulation of the thermally insulating housing is enhanced, thereby optimizing the whole heat-dissipation control and efficiency. The phase change material is the phase-change-material microcapsule or non-microcapsule phase change substance.

What is claimed is:

1. A method for manufacturing a thermally insulating housing, comprising:
forming a plastic housing by a Gas-Assisted Injection Molding (GAIM) process, and the plastic housing including at least one air-tight chamber.

2. The method for manufacturing the thermally insulating housing according to claim 1, further comprising:
filling the at least one air-tight chamber with a phase change material.

3. The method for manufacturing the thermally insulating housing according to claim 2, wherein the phase change material is enclosed by a plurality of phase-change-material microcapsules.

4. The method for manufacturing the thermally insulating housing according to claim 3, wherein the phase change material is paraffin wax or alkanes.

5. The method for manufacturing the thermally insulating housing according to claim 2, wherein each of the plurality of phase-change-material microcapsules comprises a capsule shell and a capsule core, the capsule core is disposed in the capsule shell, the material of the capsule shell is polymer, and the capsule core comprises the phase change material.

6. The method for manufacturing the thermally insulating housing according to claim 5, wherein the polymer is a mixture of Polycarbonate (PC) and glass fiber, and the phase change material is paraffin or alkanes.

7. The method for manufacturing the thermally insulating housing according to claim 5, wherein the phase change material is icosane (namely, eicosane) or triacontane.

8. The method for manufacturing the thermally insulating housing according to claim 1, wherein the material of the plastic housing is a mixture of polycarbonate and acrylonitrile butadiene styrene resin (ABS resin).

9. The method for manufacturing the thermally insulating housing according to claim 1, wherein the number of the at least one air-tight chamber is plural.

10. The method for manufacturing the thermally insulating housing according to claim 1, wherein the volume of each of the at least one air-tight chambers is between 0.125 mm³ to 8 mm³.
